(19) United States
(12) Patent Application Publication
(10) Pub. No.: US 2015/0106152 A1
(43) Pub. Date: Apr. 16, 2015

(54) CONTINUOUSLY TRACING ISSUES THROUGH THE LIFECYCLE PHASES OF A PROJECT

(71) Applicant: Microsoft Corporation, Redmond, WA (US)

(72) Inventors: Arijit Basu, Bellevue, WA (US); Satish J. Thomas, Sammamish, WA (US); Sridhar SRINIVASAN, Sammamish, WA (US)

(73) Assignee: Microsoft Corporation, Redmond, WA (US)

(21) Appl. No.: 14/053,353

(22) Filed: Oct. 14, 2013

(51) Int. Cl. G06Q 10/06

(52) U.S. Cl. CPC G06Q 10/06316; G06Q 10/0635
USPC 705/7.26

(57) ABSTRACT

A set of lifecycle services are employed to identify tasks and other worklist items. The worklist items are aggregated into a unified worklist that is synchronized to a product management system so the status of the worklist items can be traced throughout a project lifecycle.

### BACKGROUND

Many different types of computer systems are currently in wide use. Some such systems are quite large, often involving hundreds or thousands of forms that users of the systems interact with. Deploying these types of systems in an organization can be very difficult.

By way of example, some such computer systems include business systems, such as enterprise resource planning (ERP) systems, customer relations management (CRM) systems, line-of-business (LOB) systems, among others. These types of business systems often exist as a base system. However, when they are deployed within an organization, the base system is often modified or customized to meet the needs of the particular organization.

In order to implement the business system at an organization, the project of implementing the business system often goes through a number of different phases. During a pre-sale phase, for instance, the organization obtains preliminary information. The preliminary information may indicate, for instance, the number of licenses and the license fees which may be needed in order to run the business system at that organization. During an analysis phase, the particular needs of the organization are often evaluated against the functionality that is provided by the base business system. Differences between the requirements of the organization and the functionality provided by the business system are often referred to as gaps. The gaps are identified as areas where the basic business system is to be customized or modified in order to meet the functionality requirements of the organization. During a design phase, the customizations that are needed to meet the needs of the organization (e.g., to fill the gaps) are designed. That is, the modifications to the basic business system are identified, and further development, or modifications of the existing system, are identified as items that must be performed in order to meet the needs of the organization.

During a development and testing phase, the customizations to the basic business system are actually made, and the functionality of the customized system is tested to determine whether it meets the needs of the organization. During the development and testing phase, code is actually being written or customized by developers. At times, the code can be analyzed to determine whether it conforms to best practices, or whether certain changes or optimizations can be made for the code to perform better.

A final phase may be a deployment and maintenance phase in which the customized business system is actually deployed at the organization, and its ongoing operation in the production environment is maintained and updated. During this final phase, bugs are often identified and fixed and various optimizations and upgrades can be identified and deployed in order to maintain the code base.

These are only exemplary phases and many others can be used. Also, each phase may also have many different tasks, in addition to those mentioned above. During all of these phases, a wide variety of different types of issues arise. However, these different phases are often performed by different people. For example, a first set of consultants may be brought in to analyze the needs of the organization and to estimate the number of licenses, and the costs involved to obtain a customized system. During the analysis phase, a second set of consultants may be brought in to identify and document the gaps between the basic business system and the particular functional requirements of the organization that is purchasing the system. During the design phase, yet another set of consultants is often brought in to design the customized system that will eventually be deployed. However, during the development and testing phase, yet another set of people (software developers) are employed to actually develop and customize the code in order to meet the design specifications developed during previous phases. During the deployment and maintenance phase, another set of people are often employed (such as a separate set of developers or software engineers) that actually deploy the system and maintain it.

It can thus be seen that the lifecycle of such a project involves a wide variety of different phases. Also, the group of people that conduct the work during each of the phases is often different. Therefore, many of these types of projects fail in that the customer expectations for the final system do not meet what is actually delivered. It is very difficult to trace whether the customer expectations identified in the early phases actually make it into the product deployed in the final phases. This can result in customer dissatisfaction, and a relatively large amount of wasted time and money. Often, in fact, such projects are never even completed.

The discussion above is merely provided for general background information and is not intended to be used as an aid in determining the scope of the claimed subject matter.

### SUMMARY

A set of lifecycle services are employed to identify tasks and other worklist items. The worklist items are aggregated into a unified worklist that is synchronized to a product management system so the status of the worklist items can be traced throughout a project lifecycle.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one embodiment of a project lifecycle management architecture.

FIGS. 1A and 1B are more detailed block diagrams of the architecture shown in FIG. 1.

FIG. 2 is a flow diagram illustrating one embodiment of the operation of the architecture shown in FIGS. 1-1B, in performing issue and task tracing.

FIG. 3 is one embodiment of a user interface display.

FIG. 4 is one embodiment of a user interface display.

FIGS. 4A-4J are exemplary user interface displays that form a part of a lifecycle project status report.

FIG. 5 shows one embodiment of the project management lifecycle architecture deployed in a cloud architecture.

FIGS. 6-11 show various embodiments of mobile devices.

FIG. 12 shows a block diagram of a computing environment.

### DETAILED DESCRIPTION

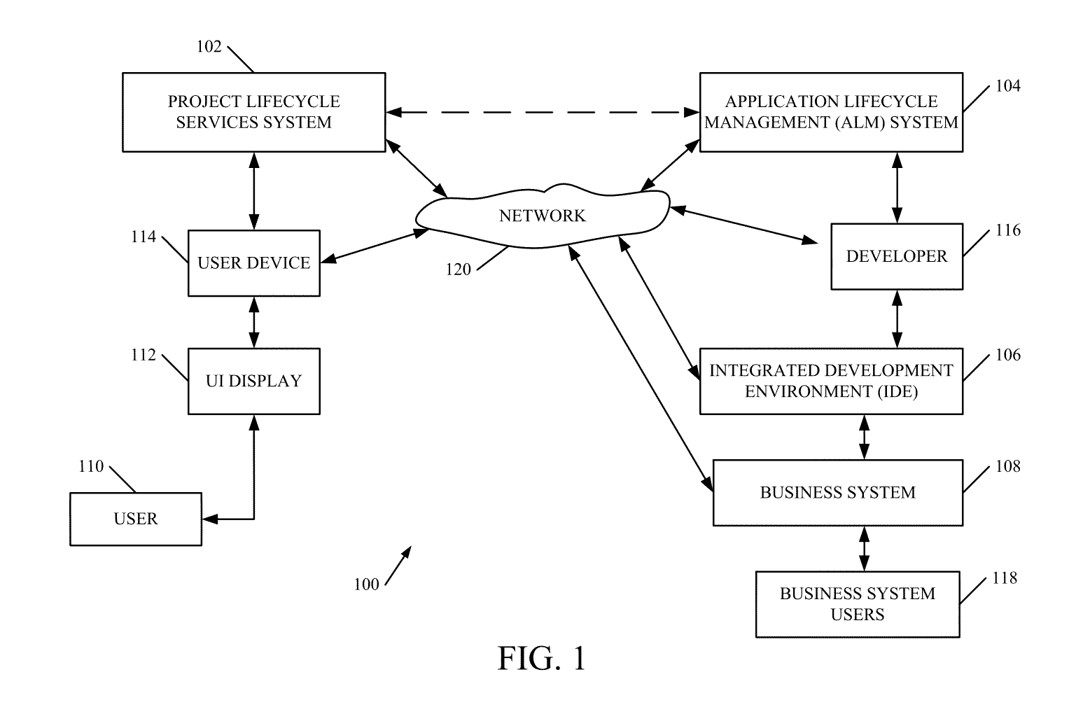

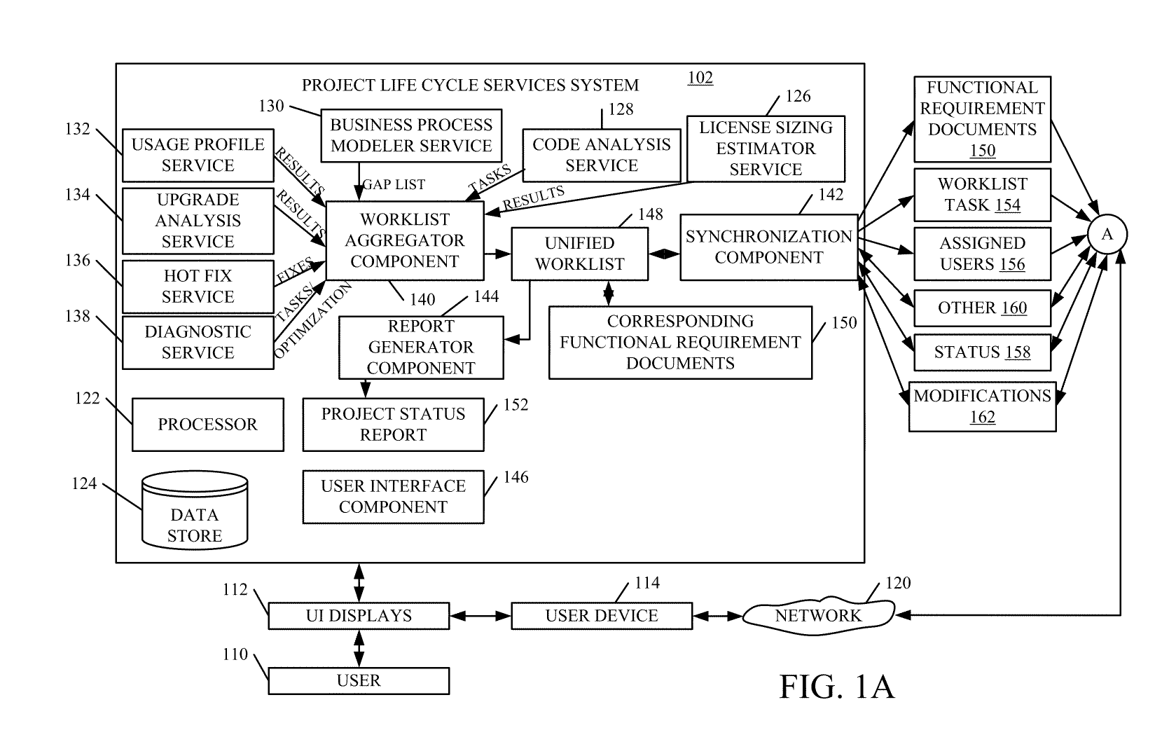

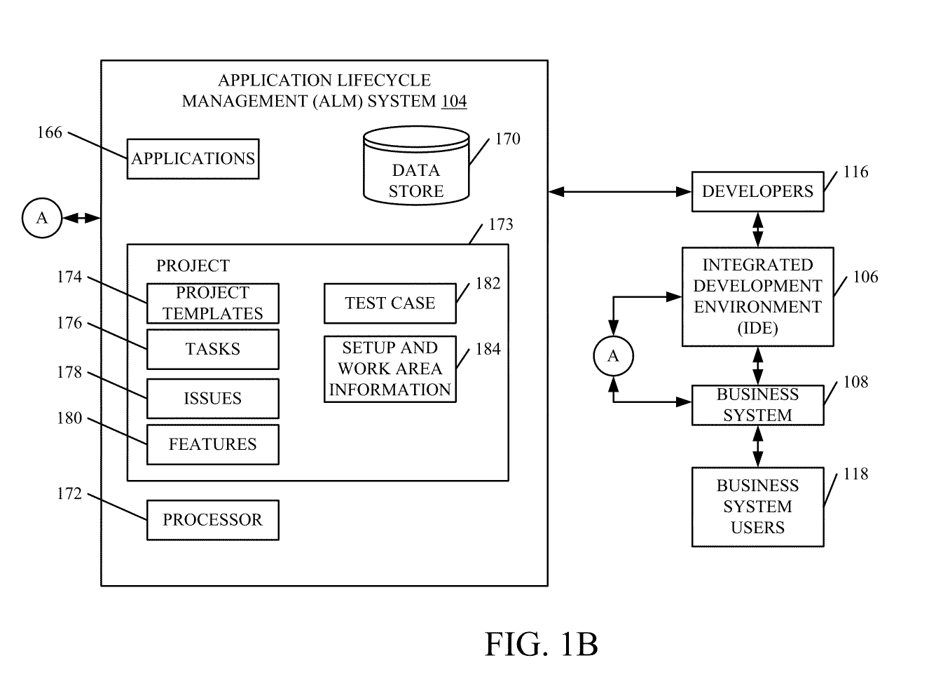

Architecture 100 illustratively includes project lifecycle services system 102, application lifecycle management (ALM) system 104, integrated development environment (IDE) 106 and business system 108. FIG. 1 also shows that a user 110 illustratively accesses project lifecycle services system 102 by interacting with user interface displays 112 that can be generated either directly from system 102, or from a user device 114. FIG. 1 also shows that developers 116 illustratively interact with IDE 106 and ALM system 104. Business system end users 118 illustratively interact with business system 108. FIG. 1 also shows that the various components and systems shown can interact with one another directly, or through one or more networks 120. In one embodiment, network 120 is illustratively a wide area network, but it could be a local area network or other types of networks as well.

Business system 108 is illustratively a customer relations management (CRM) system, an enterprise resource planning (ERP) system, a line-of-business (LOB) system or another type of business system. It is illustratively deployed at a user's organization in order to help the user perform business operations.

In the architecture shown in FIG. 1, a customer (such as an organization) may be looking to deploy a business system (such as business system 108) within their organization so that it can be used by employees of the organization, which would then be business system end users 118. Therefore, it is assumed that the customer organization begins a pre-sale process during which they shop for a suitable business system to deploy within their organization. If that is the case, then the customer is beginning at the front end of the business system lifecycle—the pre-sale phase. The customer may also have already decided to purchase business system 108, in which case the project may be in the analysis phase. In the analysis phase, the customer may be attempting to identify gaps that need particular customizations or further developments to be performed in order for business system 108 to fully meet the needs of the customer.

The customer may also be in the design phase of the project. In that phase, the customer may be employing individuals to design the customizations or further development that need to be performed in order to customize business system 108 sufficiently.

It may also be, however, that the customer has already purchased business system 108 and developers 116 are in the process of customizing business system 108 so that it meets the functional requirements of the organization deploying it. In doing so, developers 116 illustratively perform development operations within integrated development environment (IDE) 106 to develop the customizations to business system 108 that need to be made in order to meet the requirements of the purchasing organization. Of course, the business system 108 may already be deployed and it is simply being maintained. In that case, it may be in the deployment and maintenance phase of the lifecycle.

During each of these phases, the customer (which can be user 110) illustratively accesses project lifecycle services system 102. System 102 illustratively provides a plurality of different kinds of services that can be used to obtain valuable information during the different phases of a project lifecycle. In one embodiment, project lifecycle services system 102 illustratively provides a collaborative work space that customers and partners can use to manage projects surrounding the lifecycle (such as from pre-sale to deployment and maintenance) of business systems, such as business system 108. Based upon the particular phase that the project currently resides in, project lifecycle services system 102 illustratively provides checklists and a variety of different tools or services that assist in managing the project. It illustratively provides a dashboard display that can be generated on user interface displays 112, that show user 110 updated information corresponding to the particular phase in which the project currently resides. This is described in greater detail below with respect to FIGS. 1A and 1B.

Suffice it to say at this point, however, that system 102 illustratively identifies issues, tasks, fixes, diagnostic results and other information throughout the entire lifecycle of the project, all of which needs to be addressed during the lifecycle of the project. The end result of addressing all of these items is the successful deployment of business system 108, for the customer, along with continued observation and maintenance of system 108.

All of the information generated by system 102 is illustratively aggregated on a unified worklist which forms a list of tasks, issues, bug fixes, and other items that need to be traced and perhaps resolved, during the lifecycle of the project. This information is provided to ALM system 104 where the customer, and developers 116, have access to the information. ALM system 104 illustratively provides source control, data collection, reporting, and project tracking functionality for various different types of collaborative software development projects. By way of example, where the project is to customize a basic business system so that it can be deployed as business system 108 in a particular customer's implementation, that project can be managed through ALM system 104.

The developers 116 illustratively use integrated development environment 106 to perform the tasks or modify the tasks on the unified worklist. Integrated development environment (IDE) 106 is illustratively a development tool or development environment that includes a plurality of different tools so that developers 116 can develop and test the code that needs to be developed in order to customize business system 108 accordingly. For example, it may include a source code editor, build automation tools and a debugger that allow computer programmers to develop software. Some IDEs 106 illustratively include a compiler, an interpreter, or both. They may include a version control system and various tools to simplify the construction of graphical user interfaces. They can also include a class browser, an object browser, and a class hierarchy diagram for use with object oriented software development. Thus, developers 116 can use IDE 106 to generate the code and customizations that may be utilized in developing business system 108 for use in the customer organization.

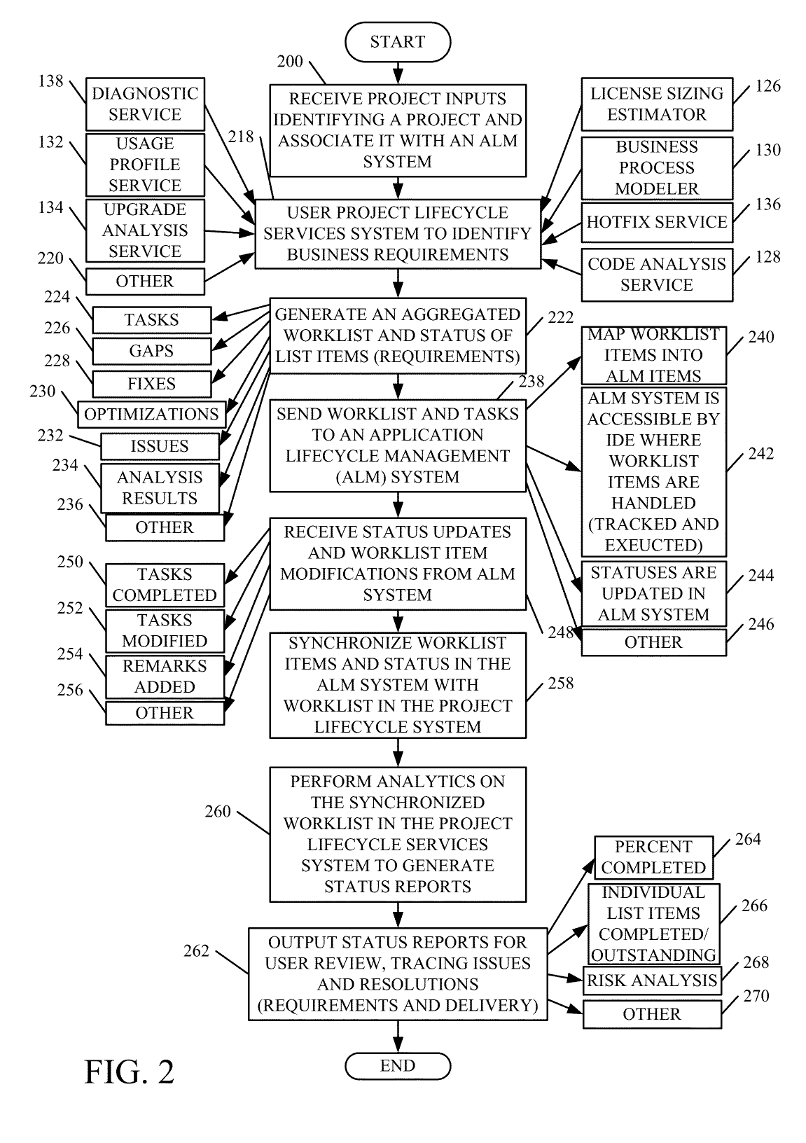

Once a task has been modified or performed (or at least partially performed), the developers illustratively update the status of that worklist item on the unified worklist. This information is communicated from ALM system 104 back to project lifecycle services system 102, where it is synchronized with the unified worklist generated in system 102. Therefore, the customer (or other user 110) can have system 102 perform analytics on the unified worklist to obtain a project status report, to obtain a risk analysis indicating which parts of the project may be at risk for not being completed or not being completed on time, and other similar information. All of this information is described in greater detail below with respect to FIGS. 1A-2.

FIGS. 1A and 1B show architecture 100, but with project lifecycle services system 102 and ALM system 104 shown in more detail. FIG. 1A shows that system 102 illustratively includes processor 122, data store 124, license sizing estimator 126, code analysis service 128, business process modeler service 130, usage profile service 132, upgrade analysis service 134, hot fix service 136, diagnostic service 138, worklist aggregator component 140, synchronization component 142, report generator component 144 and user interface component 146.

FIG. 1A shows that worklist aggregator component 140 receives inputs from services 126-138 and generates a unified worklist 148. Some worklist items have corresponding functional requirement documentation 150. FIG. 1A also shows that user 110 can use report generator component 144 to generate a project status report 152 (or other reports), which can show the status of a given project in the various lifecycle phases. It can also summarize a variety of different types of information, provide risk analysis information, provide various checklists of worklist items that are to be completed, etc.

FIG. 1A shows that system 102 provides a variety of information to ALM system 104, either directly, or over network 120. That information can include the functional requirement documents 150, unified worklist 148, worklist tasks 154, assigned users (users assigned to complete those tasks) 156, status information corresponding to each of the worklist items 158, modifications that may be made to the worklist items, and other information 160. FIG. 1A also shows that system 102 can receive various information, such as status information 158, modifications 162 to worklist items, and other information 160, from ALM system 104. Synchronization component 142 illustratively synchronizes information sent from, and received at, system 102 in unified worklist 148.

FIG. 1B shows that ALM system 104 illustratively includes applications 166 and data store 170, along with processor 172. The applications 166 illustratively allow developers 116 and project managers to manage projects.

FIG. 1B shows that application lifecycle management system (ALM system) 104 not only includes applications 166 and data store 170, but it also illustratively includes project management information for individual projects. FIG. 1B shows an exemplary project 173. The information used to manage project 173 includes project templates 174, tasks 176, issues 178, features 180, test cases 182 and setup and work area information 184.

Before describing the operation of architecture 100 in more detail, a number of the various services, components, and other items will be described.

Project lifecycle services system 102 illustratively allows the user to track projects throughout the entire lifecycle. In doing so, it employs a variety of the services 126-138. License sizing estimator service 126, for instance, helps a user to estimate the number of licenses required for a business system. It can provide a shared work space that enables the user to model default and customized roles, and then automatically calculate client access licenses that may be needed by the system.

Code analysis service 128 illustratively receives code that is authored by developers 116 during the customization process. It performs analysis and validates model files against best practices. It can provide a report of potential areas for improvement. In addition, it can provide tasks that can be performed in order to improve the code.

Business process modeler service 130 illustratively allows a user to create, view and modify standard process flow inside the business system 108. By using modeler service 130, the user can standardize process flows and align the processes within business system 108 with industry standard processes. In addition, business process modeler service 130 can generate a fit gap list which identifies both the functionality needed by the user and that provided by business system 108. It then identifies existing functionality provided by system 108 that meets requirements of the customer (i.e., the fits). It also identifies functionality that is needed by the customer, but that is not provided by business system 108, in its basic form (i.e., the gaps). The fit gap list provides a developer with useful information in determining which particular customizations need to be made, or which further development needs to be performed, in order for the customized business system to meet the functional needs of the end user or customer.

Usage profile service 132 is illustratively a data gathering tool that helps to describe the projected or current usage of business system 108 in a current or future implementation. A usage profile is generated, and it can be used for a wide variety of different purposes. For instance, it can be used to estimate the sizing of hardware components that are to be used in the implementation, or that should be used in an existing implementation, along with the support that will be necessary for such an implementation.

Upgrade analysis service 134 illustratively allows a user to analyze when various upgrades to business system 108 will be useful. It illustratively analyzes code artifacts from business system 108 to determine whether upgrades would be useful, and it also illustratively provides a rapid data collection tool that analyzes existing environment information in an existing implementation of business system 108, in order to help estimate the scale of the upgrade project that may be recommended.

Hot fix service 136 illustratively allows a user to search for existing solutions and workarounds for known issues in the particular business system 108 being deployed. A user can identify which issues have been fixed, and which issues remain open, as well as which issues have been resolved as issues that will not be fixed. Thus, when deploying business system 108, the developer or user can quickly identify whether solutions have already been generated for various problems or bugs that may be encountered.

Diagnostic service 138 illustratively allows the user or administrator to monitor the environment in which business system 108 is deployed. In one embodiment, service 138 can be pointed to a given environment employing a business system 108 and diagnostic service 138 can run a variety of different tests and output various tasks or optimizations that can be made to improve the performance of business system 108.

Other or different services can be provided in system 102 as well. These are exemplary only.

It can be seen that all of these services 126-138 illustratively provide outputs. The outputs can be provided in a variety of different forms. For instance, they can simply be results which indicate usage profile information, license estimation results, results that indicate whether upgrades should be made, etc. Also, they can be outputs in the form of issues that need to be resolved, and the potential fixes for those issues, optimizations that can be made to increase the performance of the business system, tasks that are to be performed in order to make those optimizations, a fit gap list, tasks generated from code analysis service 128 that can be used to conform the code being written by developers 116 to best practices, etc.

Worklist aggregator component 140 illustratively aggregates the outputs of all of the services and generates a unified worklist 148. The unified worklist 148 includes list items, some of which have corresponding functional requirement documents 150. Synchronization component 142 illustratively provides the worklist tasks or other worklist items 154 along with any functional requirement documents 150, and an indication of which particular users (e.g., which developers 116, if any) have been assigned to the various tasks for the given project. It can also, of course, provide other information 160 as well. ALM system 104 illustratively receives the outputs from project lifecycle services system 102 and places them in the proper place for a given project 173. For instance, project identification information can be placed in project templates 174. Tasks 176, issues 178, features 180, and the other information can illustratively be populated from the worklist tasks 154, and the various worklist items on unified worklist 148, that are provided by synchronization component 142.

Developers 116 illustratively access the tasks and worklist items in ALM system 104 and work on those worklist items within integrated development environment 106. Developers 116 then also update the status of the various worklist items, once they have been worked on. For instance, if a developer completes one of the tasks on the unified worklist, developer 116 will update the status of that task to “completed” within ALM system 104.

Synchronization component 142 receives the status update 152 and synchronizes it to unified worklist 148 in system 102. It will be appreciated that developers 116 can provide modifications 162 to the worklist items as well. For instance, if a task on unified worklist 148 needs to be modified, after a developer 116 has begun working on it, the developer can reflect those modifications on the unified worklist 148 by simply providing them to ALM system 104 where they will be synchronized using synchronization component 142, back to unified worklist 148 in system 102.

User 110 can illustratively use report generator component 144 to generate reports against the items on unified worklist 148. Such reports can include, by way of example, a project status report 152 which will allow user 110 to trace the various issues raised during the different phases of the lifecycle of the project, from their inception, all the way through completion and delivery and final implementation and production of the business system 108.

FIG. 2 is a flow diagram illustrating one embodiment of the overall operation of architecture 100 shown in FIGS. 1-1B. FIGS. 1-2 will now be described in conjunction with one another.

System 102 first illustratively generates user interface displays 112 that allow user 110 to provide inputs identifying a project and associating it with a particular ALM system 104. This is indicated by block 200 in FIG. 2.

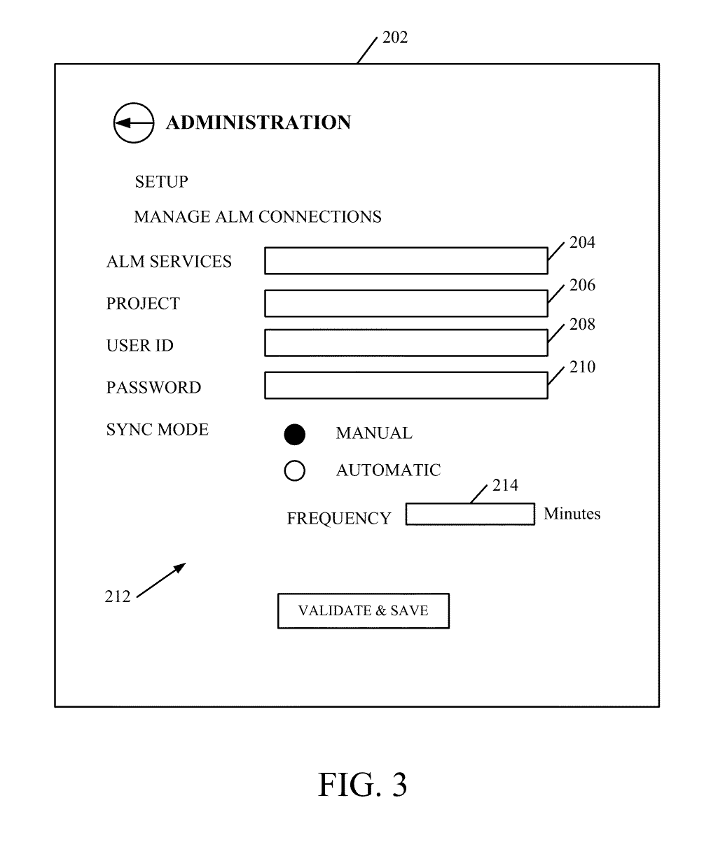

FIG. 3 shows one example of a user interface display 202 that can be generated to do this. It can be seen that user interface display 202 is illustratively a setup display that identifies user 110 to manage connections with ALM system 104. In the embodiment shown in FIG. 3, display 202 illustratively includes an ALM source field 204, a project field 206, and authentication information which includes a user ID 208 and a user password 210. Display 202 also includes synchronization inputs 212 that allow user 110 to set up the particular mechanism for synchronizing information (using synchronization component 142) between system 102 and system 104.

Therefore, a user can illustratively input the name of a particular ALM service in text field 204. The user can identify a particular type of project in field 206 and input the user's ID and password in fields 208 and 210. The user can then choose between a manual synchronization mode and an automatic synchronization mode, using user input mechanisms 212. If the user chooses an automatic synchronization mode, then the user can set a frequency in field 214 with which synchronization component 142 will synchronize items from ALM system 104 to unified worklist 148, and vice versa.

Once the communication between system 102 and system 104 has been set up, user 110 illustratively uses the various services and components in system 102 to identify business requirements that the user has, and in order to determine which types of customizations and further development may be made, with respect to a base business system 108, in order to meet those requirements. Using project lifecycle services system 102 to identify the business requirements is indicated by block 218 in FIG. 2.

Again, those business requirements can include outputs from the license sizing estimator service 126, the business process modeler 130, the hot fix service 136, the code analysis service 128, the diagnostics service 138, the usage profile service 132, the upgrade analysis service 134, or any of a wide variety of other services 220. Based upon the output from services 126-138, or other services 220, worklist aggregator component 140 illustratively generates an aggregated worklist (identified by unified worklist 148 in FIG. 1A) that has a set of worklist items, and each of which can have an associated status. The worklist items illustratively identify the various things which are to be done in order to fully implement business system 108 for the given customer. Generating the aggregated (and unified) worklist 148 is indicated by block 222 in FIG. 2. As briefly discussed above, the worklist items can include tasks 224, gaps 226, fixes 228, optimizations 230, various other issues 232, analysis results 234, and other information 236 as well. All of these items can be included on the aggregated, unified worklist 148.

Synchronization component 142 then sends the worklist and the associated tasks and documentation, assigned users, and other information to the previously-selected ALM system 104. This is indicated by block 238 in FIG. 2. In one embodiment, ALM system 104 (or system 102) illustratively maps the worklist items into the ALM items for a given project (such as project 173). This is indicated by block 240 in FIG. 2.

The ALM system 104 is illustratively accessible by developers 116 (such as through IDE 106 or otherwise). The worklist items are thus tracked and executed, or performed, by developers 116, using IDE 106. This is indicated by block 242 in FIG. 2. The various statuses for the worklist items are updated in ALM system 104 by the developers or other users of ALM system 104, and modifications can be made to the items on the unified worklist as well. This is indicated by block 244 in FIG. 2. Developers 116 can perform other tasks or items within system 104, that are reflected on the unified worklist as well, and this is indicated by block 246.

ALM system 104 then sends this information back to project lifecycle services system 102 (or it is retrieved by system 102 from system 104). This is indicated by block 248 in FIG. 2. The information received can indicate that one or more tasks on the worklist have been completed as indicated by block 250. It can also indicate that tasks or other information on the unified worklist have been modified, as indicated by block 252. It can include remarks on the worklist items that have been added by developers 116 or other persons. This is indicated by block 254. It can also include other information as indicated by block 256.

Once the information is received, it is synchronized to unified worklist 148 by synchronization component 142. This is indicated by block 258 in FIG. 2. The synchronized, unified worklist 148 can then illustratively be stored until it is accessed later (such as for synchronization or to perform analytics in order to generate a report).

When a user 110 wishes to see an update for a given project, or status summary for a given project, user 110 illustratively provides inputs through suitable user interface displays 112, to report generator component 144. Report generator component 144 then accesses the stored unified worklist 148, and performs various analytics on the information in the unified worklist 148 to generate a report, such as project status report 152. Performing analytics on the synchronized worklist in the project lifecycle services system 102 is indicated by block 260 in FIG. 2. The (status or other) reports are then output or saved for access (through UI displays 112) by various users 110 that wish to see the reports. The reports illustratively trace the issues which have been raised throughout the various lifecycle phases of the project, to unified worklist 148. The report also illustratively traces which of those issues have been resolved, and when. It can indicate various statistics with respect to whether the issues have been resolved, and other things as well. Thus, the report can illustratively show how effectively the business requirements entered in the initial phases of the project, and those that arose throughout the later phases of the project, are being resolved and delivered to the customer. Outputting the status reports for user review, and tracing issues and resolutions is indicated by block 262 in FIG. 2.

By way of example, the status report can include a percent of the issues which have been completed or resolved. This is indicated by block 264. It can include an identification of individual list items that have been completed, and those that are still outstanding. This is indicated by block 266. It can include a risk analysis section that identifies which portions of the project are at risk, and the particular issues involved. This indicated by block 268. It can include a wide variety of other information as well, as indicated by block 270.

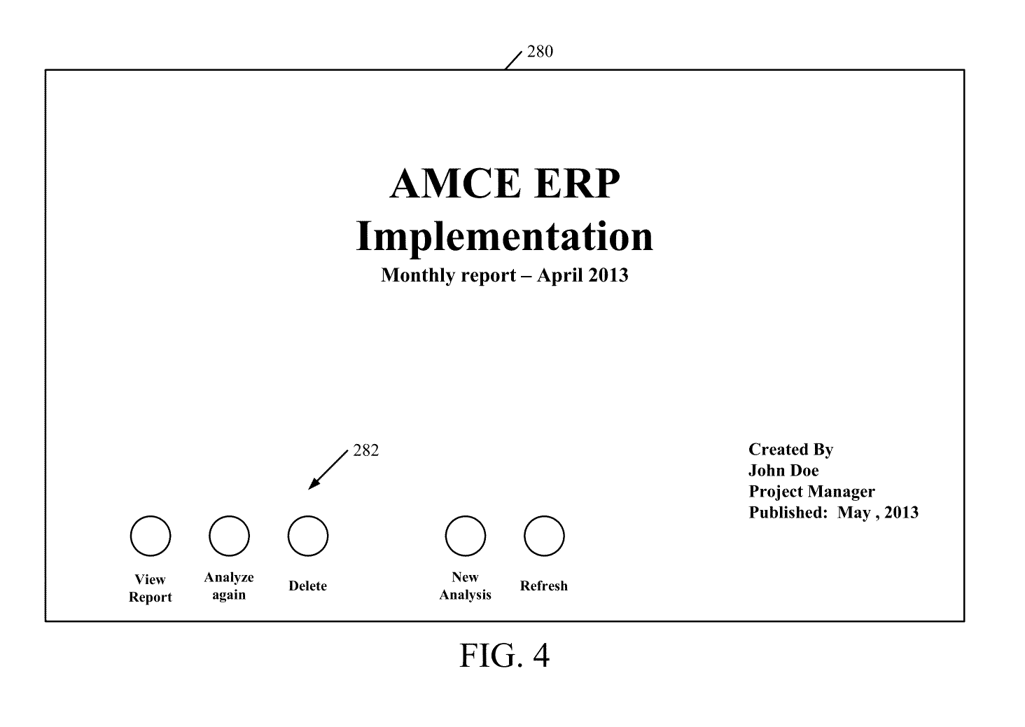

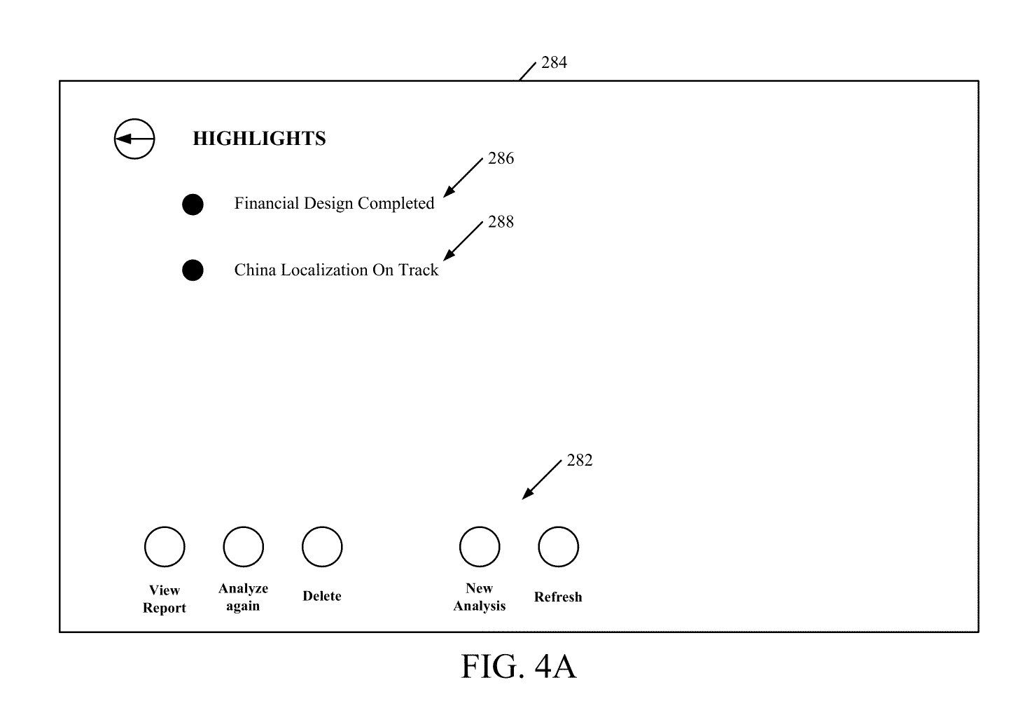

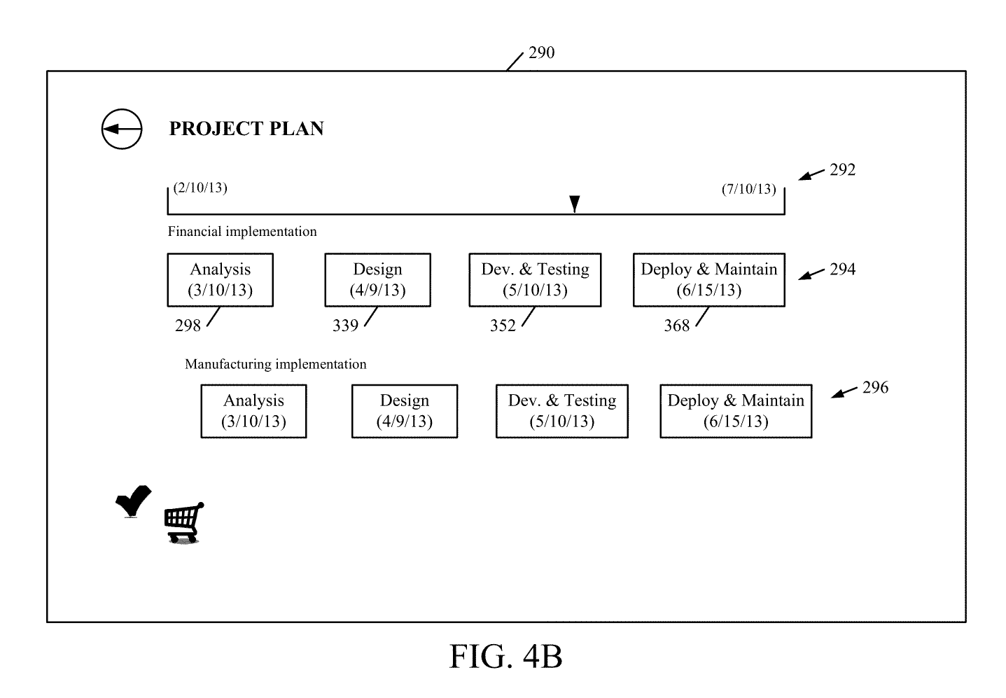

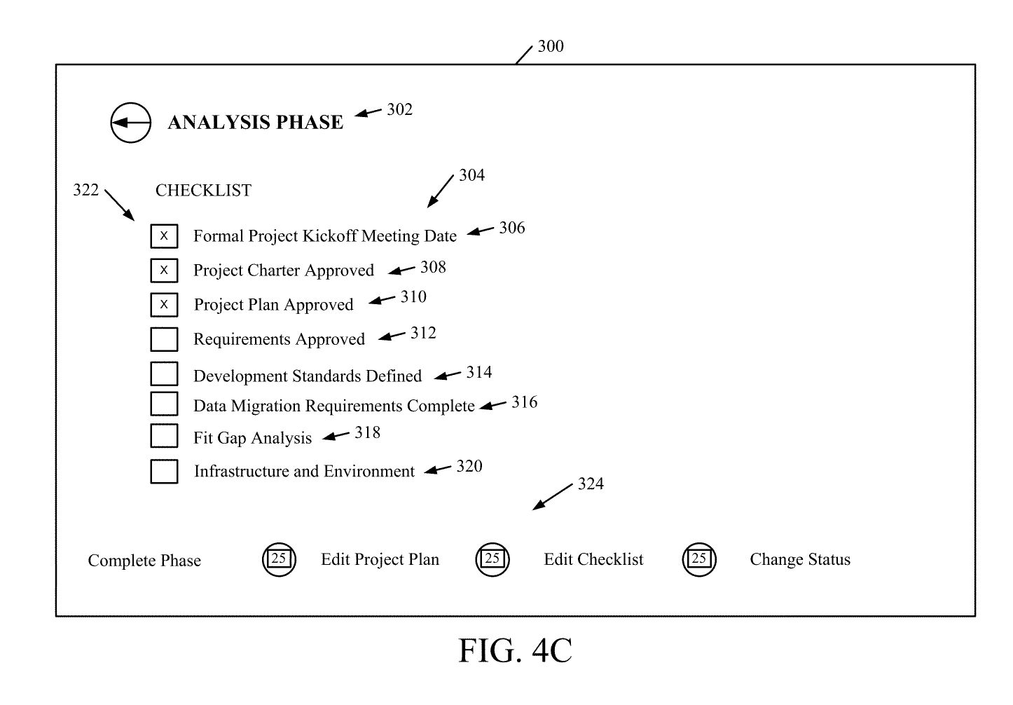

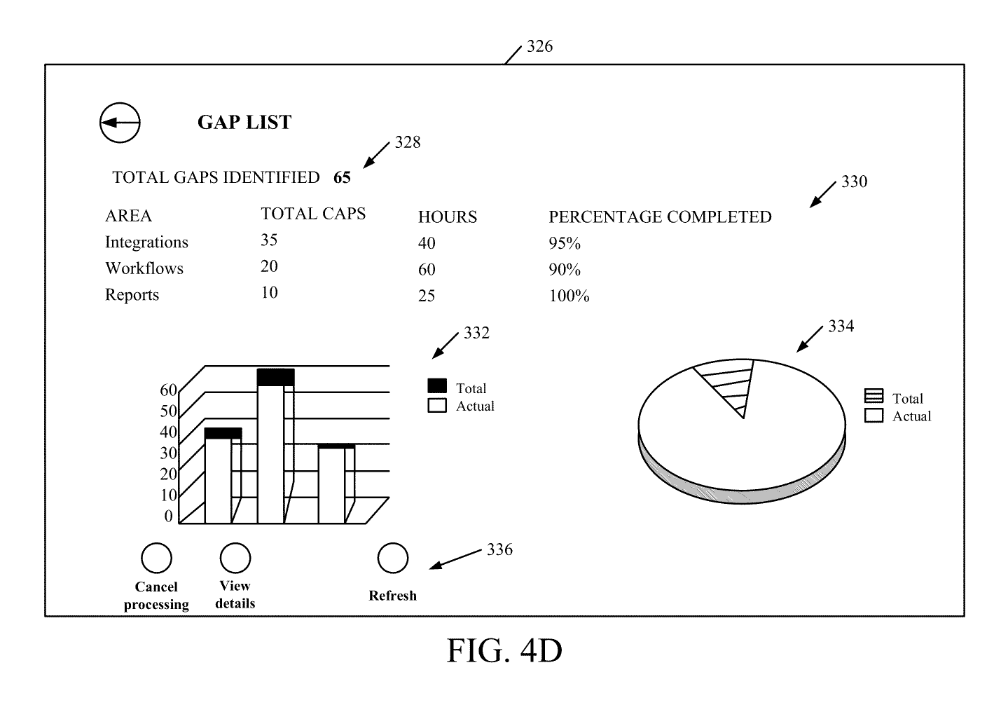

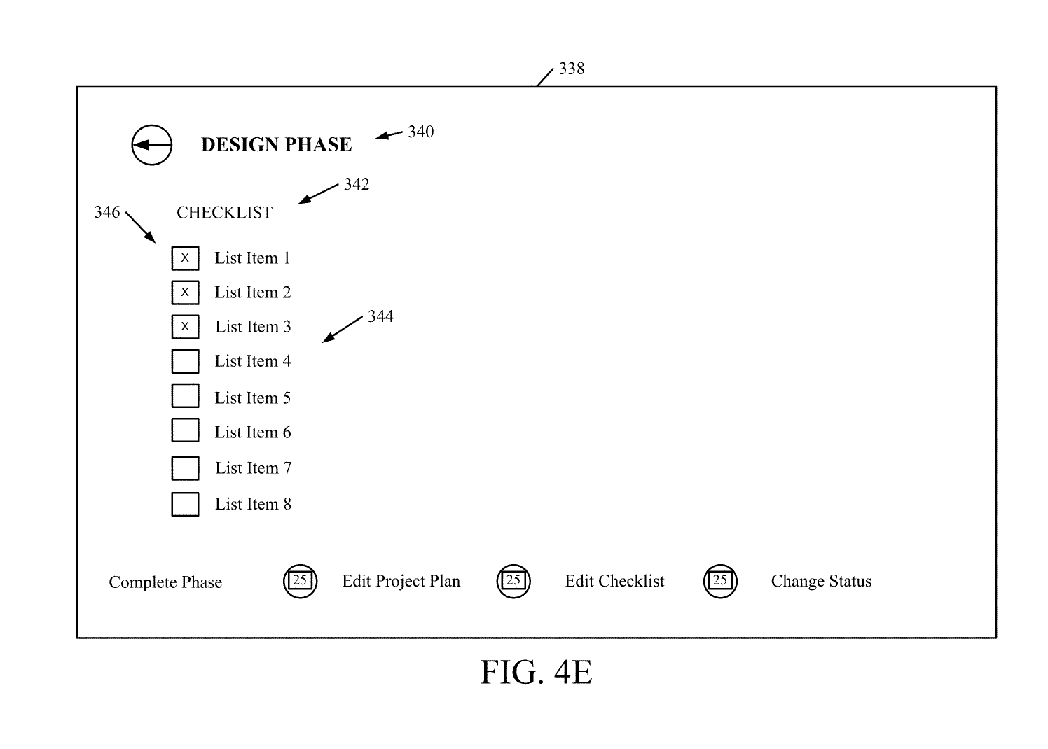

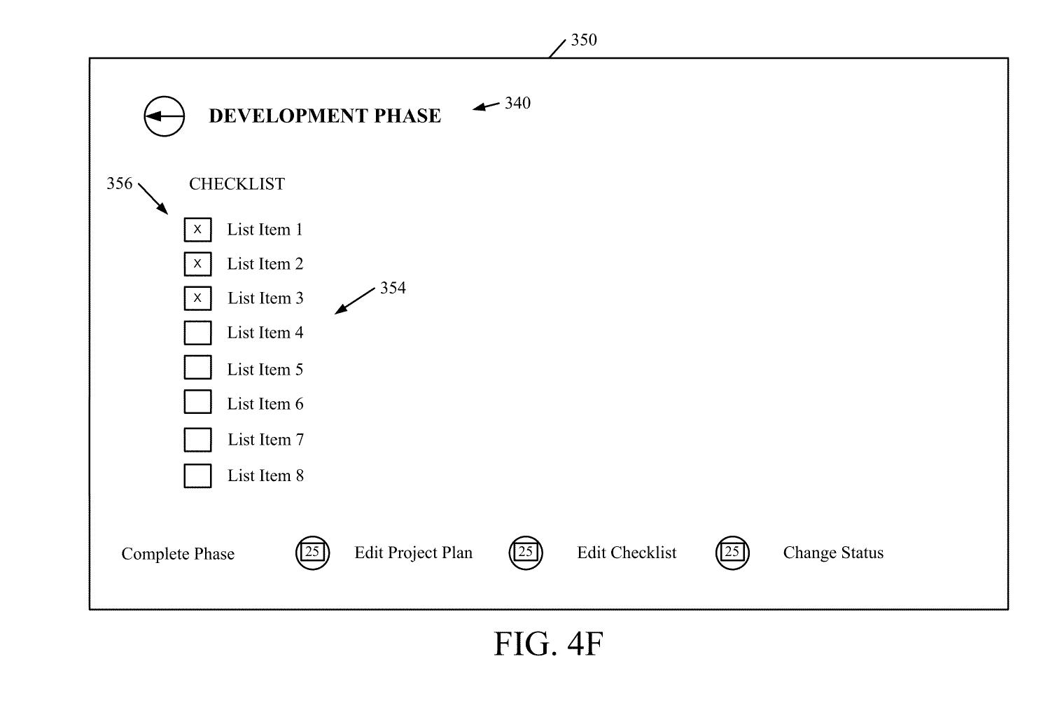

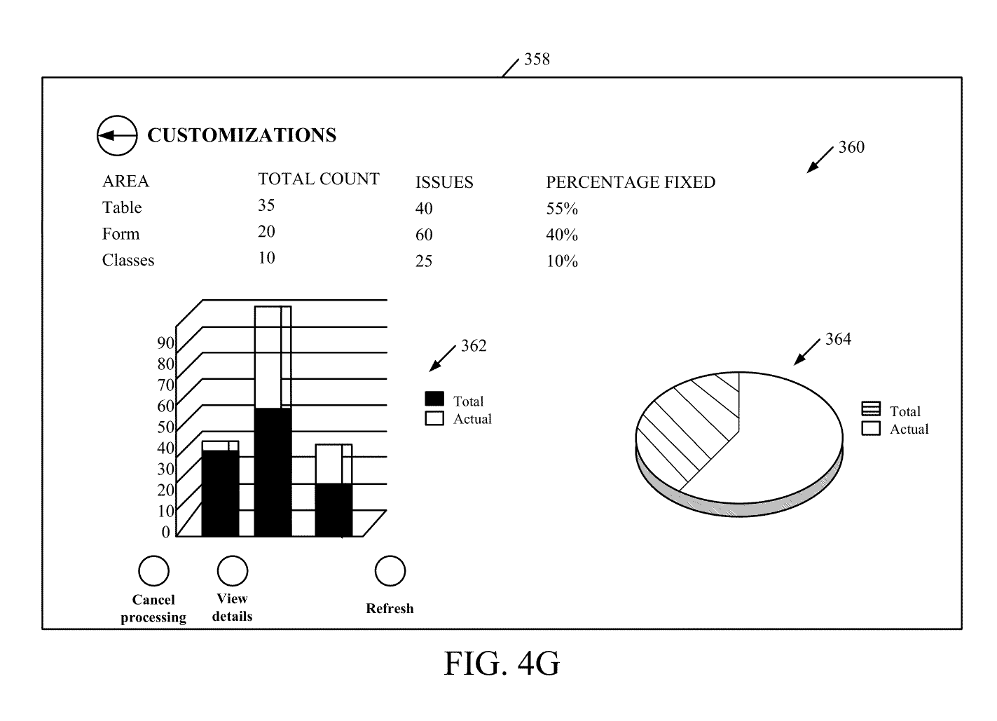

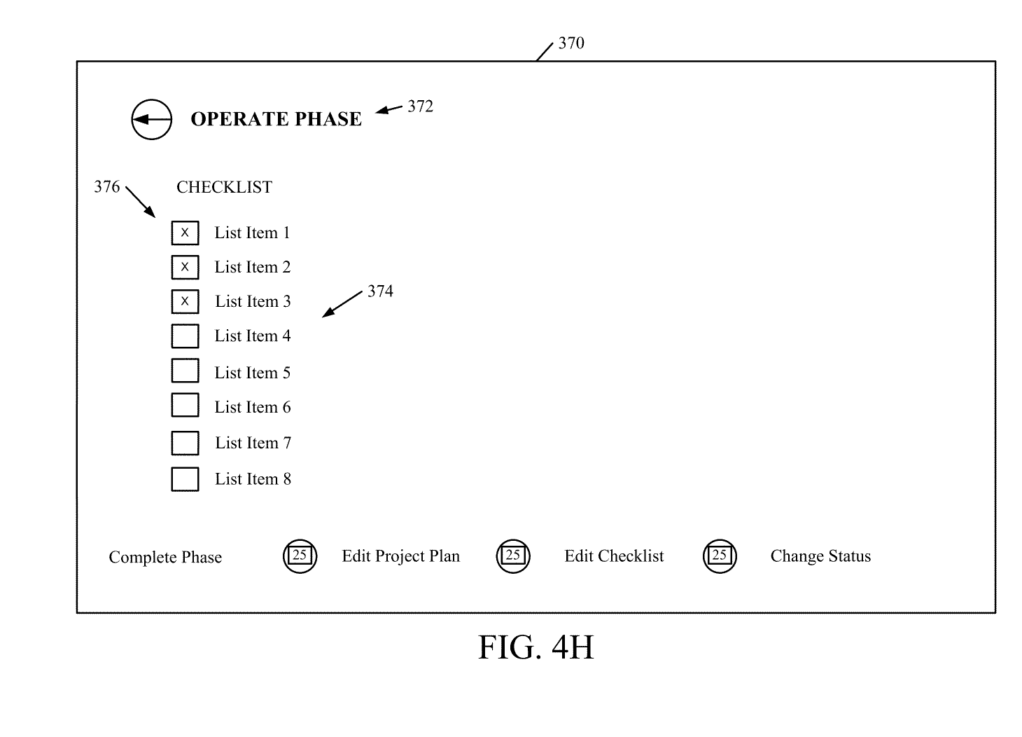

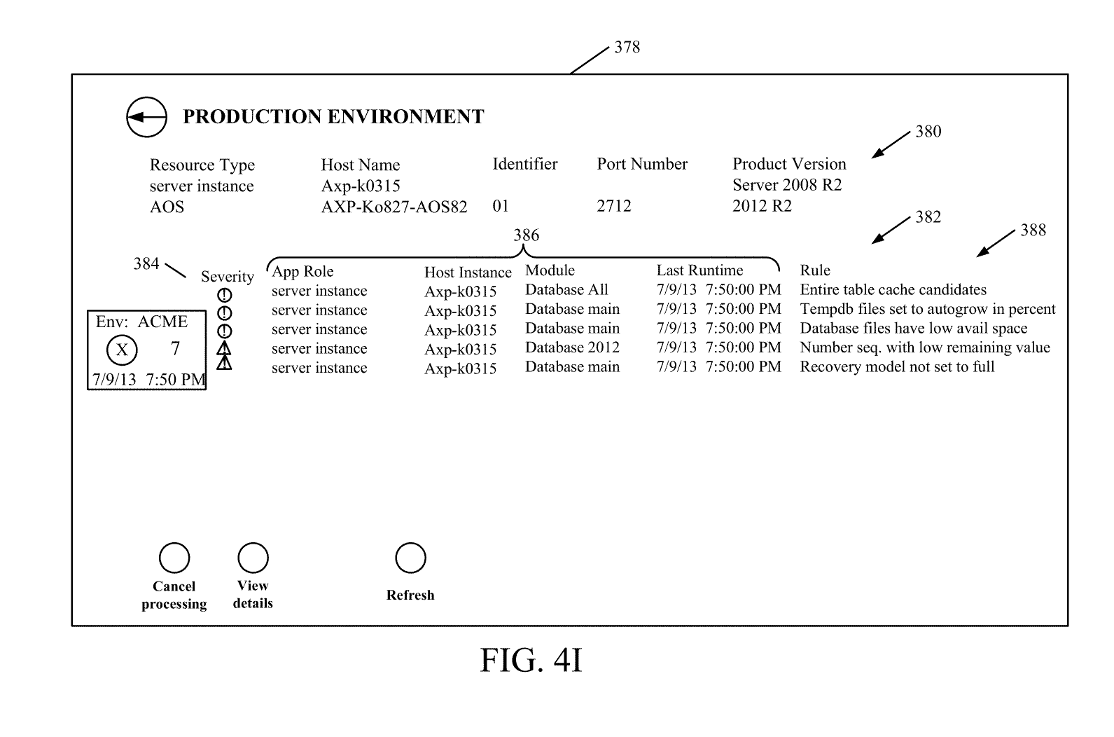

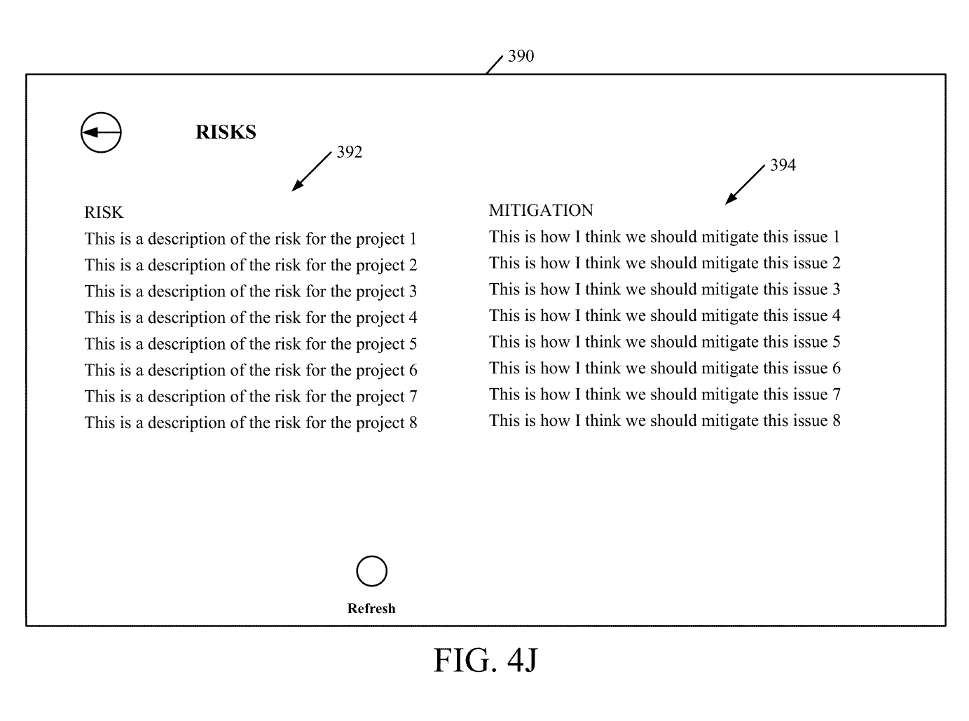

The user first accesses one or more user interface displays generated by report generator component 144 that allows the user to define the particular items the user wants in the report, and specify the particular analytics to be applied. This can be done by selecting one of a variety of pre-configured report formats or by defining a new report using suitable user input mechanisms (e.g., text boxes, search boxes, dropdown menus, etc.). FIGS. 4-4J show a variety of different exemplary user interface displays that can be generated to show one example of a project status report 152. FIG. 4 shows that report 152 can start with a title page shown by user interface display 280. A title page 280 can include a variety of user input mechanisms 282 that can be actuated by the user to view the report, perform further analysis, delete the report, perform a brand new analysis, or to refresh the report with currently synchronized information.

When the user actuates one of user input mechanisms 282 to view the report, the user can, by way of example, be navigated to a highlights page such as user interface display 284 shown in FIG. 4A. User interface display 284 illustratively includes two different facets of a project, identified as “financial design” and “China localization”. It indicates a status of those different aspects, such as “completed” or “on track”. This is indicated by user input mechanisms 286 and 288, respectively. Of course, if there are different aspects to a given project, and they have different statuses, those can be displayed as well.

In the embodiment shown in FIG. 4A, if the user actuates one of user input mechanisms 286 or 288, the user is illustratively navigated to more details with respect to that aspect of the project. For instance, if the user actuates user input mechanism 286, the user can be navigated to a “project plan” page of the project status report. One embodiment of this is illustrated by the user interface display 290 shown in FIG. 4B.

FIG. 4B shows a project plan display that shows a timeline 292, a phase-based display for the financials implementation, illustrated generally at 294, and a phase-based display for a manufacturing implementation indicated generally at 296. The user can illustratively actuate any of the various phases in displays 294 and 296, and be navigated to a more detailed page showing additional details for that given phase. For instance, if the user actuates the analysis user input mechanism 298 in FIG. 4B, the user can be navigated to an analyze phase page of the project status report. One embodiment of this is illustrated by user interface display 300 shown in FIG. 4C.

User interface display 300 includes a title 302 that indicates that the information displayed thereon is for the “analyze” phase of the project. In the embodiment shown in FIG. 4C, the information includes a checklist 304. Each checklist has a plurality of different items 306-320, all of which have an associated user interface element (such as a check box 322) to indicate whether the checklist item has been completed. The user can thus quickly determine which items are left to be completed in the analysis phase, and which items have already been completed. The display also illustratively includes a plurality of different user actuable input mechanisms 324. If the user actuates them, the user can edit the project plan, edit the specific checklist 304, or change the status of various items in the displayed information.

In one embodiment, each of the items 306-320 in checklist 304 are also actuatable user input mechanisms. When they are actuated by the user, they illustratively navigate the user to underlying information that has been generated for that particular list item in checklist 304. For example, if the user actuates the fit gap analysis user input mechanism for the list item 318 in checklist 304, the user can illustratively be navigated to an underlying gap list, such as that shown in user interface display 326 in FIG. 4D.

User interface display 326 illustratively displays a total number of gaps (at 328) that have been identified (such as by business process modeler service 130 during the analysis phase) along with the area of those gaps (such as integrations, work flows, reports, etc.) and a gap breakdown for each area, along with the number of hours that are projected as being needed to develop code to fill the gap. Display 326 also shows a percent completed, which indicates how much of the development has already been performed in order to fill the various gaps in each area. This information can be presented in tabular form as shown at 330, or in chart form as shown at 332 and 334 or in other ways. Display 326 also, itself, includes a plurality of additional user input mechanisms 336 that allow the user to view additional details corresponding to the gap list, or to refresh the information shown on display 326.

In addition, each of the items of information in table 330 or in charts 332 and 334 is illustratively a user actuatable input mechanism. Therefore, when the user actuates a given item (such as an item in table 330) the user will illustratively be navigated to a more detailed display showing more details corresponding to the actuated item. Similarly, charts 332 and 334 can be interactive as well so when the user actuates an item in one of charts 332 or 334, the user is illustratively navigated to more detailed information for that actuated item as well. When the user actuates any of the user actuable input mechanisms, the user can also navigate to the particular object that is to be modified so the items are directly actionable from the displayed user actuatable input mechanism.

FIG. 4E shows one embodiment of a user interface display 338 that can be generated when the user actuates the “design” user input mechanism 339 in FIG. 4B. Again, display 338 illustratively includes a title portion 340 along with a checklist 342 that has associated checklist items indicated generally at 344. Each checklist item illustratively includes a check box 364 (or other display element) indicating whether it has been completed. The checklist 342 will illustratively be configured to show those items, issues, tasks, etc., that arose during the design phase of the project. Again, if the user actuates one of the list items, the user can be navigated to more detailed information corresponding to that item.

FIG. 3F shows one embodiment of a user interface display 350 that may be generated, for instance, when a user actuates the development and testing phase user input mechanism 352 in FIG. 4B. User interface display 350 includes title 352 that indicates that the information displayed thereon is for the development phase. Checklist 354 includes a plurality of checklist items, again each with an associated check box 356 that indicates whether the checklist item has been performed. When the user actuates one of the checklist items, the user is illustratively navigated to a page indicating more details corresponding to that checklist item. For instance, if the user actuates one of the checklist items that relates to the number of customizations that need to be made, the user may illustratively be navigated to a user interface display such as display 358 shown in FIG. 4G.

Display 358 is similar to display 326 corresponding to the gap list, except that it is for customizations. It includes more detailed information indicating how many customizations are required, what area those customizations are required in, and the percentage of the customizations, in each area, that have already been made. This can be shown in a wide variety of different ways, such as in a table 360, or in one of a variety of different chart views, such as chart view 362, or chart view 364, or other views. Again, the items in table 360 and chart views 362 and 364 can be actuable so when they are actuated by the user they navigate the user to more detailed information.

When the user actuates the deploy and maintain phase user input mechanism 368 in FIG. 4B, the user is illustratively navigated to a more detailed user interface display, such as display 370 shown in FIG. 4H. FIG. 4H again has a title 372 that indicates that the displayed information is for the operational phase. A checklist 374 has a plurality of checklist items that correspond to the operational phase. Each of them has a corresponding check box 376 that indicates whether the list item has indeed been performed. Again, if the user actuates one of the items in list 374, the user is illustratively navigated to a more detailed display in report 152 showing more detailed information corresponding to the actuated list item.

By way of example, FIG. 4I shows one embodiment of a user interface display 378 that shows more detailed information for the production environment that corresponds to the operational phase shown in FIG. 4H. The example shown in user interface display 378 includes identifying information 380 that identifies the production environment along with a list of warnings or notifications 382. The warnings and notifications illustratively have a severity indicator 384 that shows the severity of the warning, along with identifying information 386 that identifies where and when the warning or notification was generated, along with the particular rule 388 that caused the warning to be generated. Of course, user interface display 378 is exemplary only and a wide variety of other information could be shown as well.

In one embodiment, project status report 152 also illustratively includes a risk assessment portion. FIG. 4J shows one illustrative user interface display 390 that provides risk information. In the example shown in user interface display 390, the risk assessment is presented as a list of risks 392 associated with a list of corresponding tasks 394 that can be used to mitigate the risk.

Risk section 392 illustratively describes the various risks that may indicate that a given project will not be completed on time, or that the customer's expectations or requirements will not be met. The risks can be identified in a variety of different ways. They can be items that are identified as being a sufficient time behind schedule. They can be items where developers have indicated that the worklist items are not addressable. They can be items where developers have indicated they will not be providing the requested functionality or that the requested functionality cannot be implemented without a large departure from the budget or schedule, or in other ways. The risk identifier describes the risk and the particular project that the risk is associated with. The mitigation section 394 illustratively describes various actions that can be taken (such as tasks to be performed, customizations to be generated, a suggested redeployment of development resources, etc.) that can be performed in order to mitigate or eliminate the corresponding risk.

It can thus be seen that architecture 100 provides an integration between systems 102 and 104 to enable users to synchronize work tasks and work items in the two systems and to track and trace these work items throughout the lifecycle of a given project. The unified worklist is illustratively a list of actionable items that can be tracked and executed and related to various work items in system 104. The status and other information corresponding to the unified worklist is synchronized back to system 102, and analytics are provided to analyze the items on the unified worklist to generate a wide variety of different kinds of status reports. Issues can thus be traced from the very earliest phases of a project (such as business requirement gathering) all the way through requirement delivery during an implementation, and even after implementation into the maintenance phase.

A number of the figures discussed above show processors (such as processors 122 and 172). It will be appreciated that user device 114 and IDE 106, as well as any user devices used by users 118, can include processors as well. The processors are illustratively computer processors with associated memory and timing circuitry (not always separately shown). They are illustratively a functional part of the device or system to which they belong, are activated by the various components and other items in that system or device, and facilitate their functionality.

The above discussion has also mentioned a number of data stores, such as data store 124 and data store 170. It will be appreciated, however, that IDE 106 and business system 108 can also have data stores, as can other items in the architecture described above. The data stores can be local to the environments or systems which use them, or they can be remote from those environments and systems, and accessible by them. In addition, where a single data store is shown, multiple different data stores can be employed. All of the multiple different data stores can be local to the system or environment that uses it, or they can all be remote therefrom, or some can be local while others are remote.

It will also be appreciated that a number of different blocks are shown in the Figures discussed above, and functionality is attributed to them. However, the blocks can be combined so that the same functionality is performed by fewer components, devices, or environments, or additional blocks can be added, so that the functionality is further distributed. All of these configurations are contemplated herein.

The discussion above has referred to some exemplary user input mechanisms on exemplary user interface displays. The user input mechanisms on the UI displays can take a wide variety of different forms. For instance, they can include icons, check boxes, text boxes, drop down menus, links, etc. The user input mechanisms can also be actuated in a wide variety of different ways. For instance, they can be actuated using point and click devices (such as a mouse or track ball), using hardware keyboards, keypads, buttons, thumb switches, joysticks, etc. In addition, they can be actuated using virtual keyboard or keypads or using other virtual actuating mechanisms. Further, where the device that generates the UI displays includes speech recognition components, the user input mechanisms can be actuated using voice commands. Also, where the display device on which the UI displays are displayed is a touch sensitive screen, the user input mechanisms can be actuated using touch gestures.

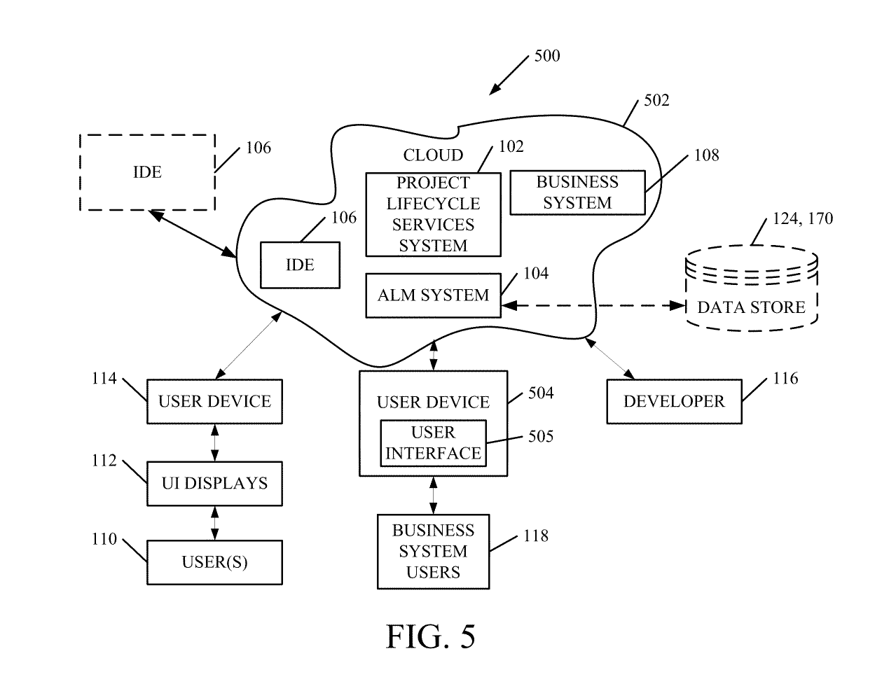

FIG. 5 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 5, some items are similar to those shown in FIG. 1 and they are similarly numbered. FIG. 5 specifically shows that systems 102, 104 and 108 and IDE 106 can be located in cloud 502 (which can be public, private, or a combination where portions are public while others are private). Therefore, users 110 or 118 uses a user devices 114 or 504, respectively, (that generate displays 112, 505) to access those systems through cloud 502. Developer 116 can also use a user device or access the systems directly.

FIG. 5 also depicts another embodiment of a cloud architecture. FIG. 5 shows that it is also contemplated that some elements of data architecture can be disposed in cloud 502 while others need not be. By way of example, data stores 124 and 170 can be disposed outside of cloud 502, and accessed through cloud 502. In another embodiment, IDE 106 is also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

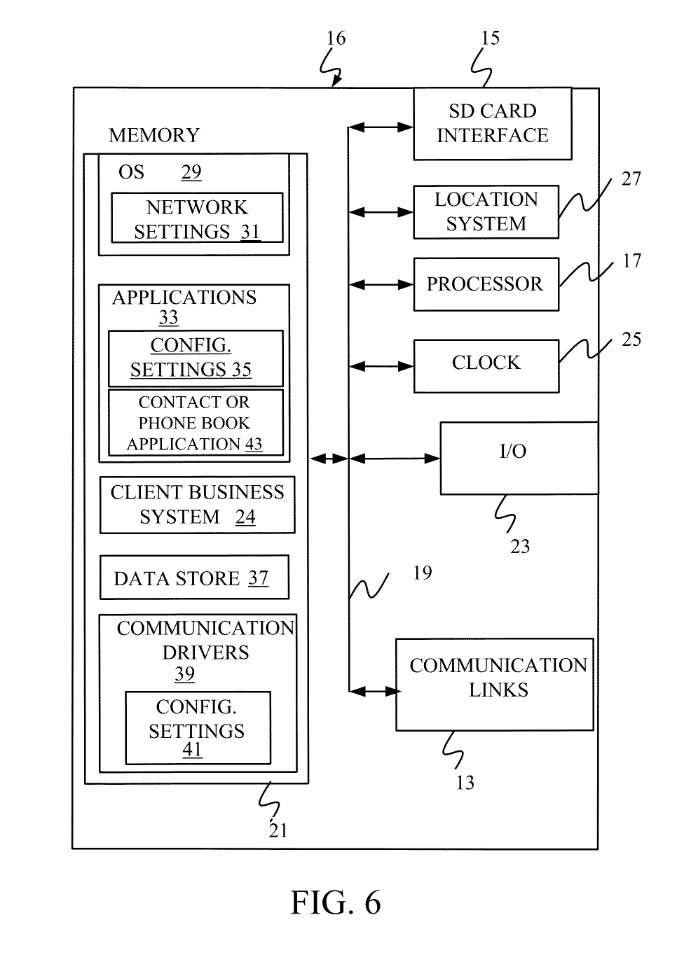

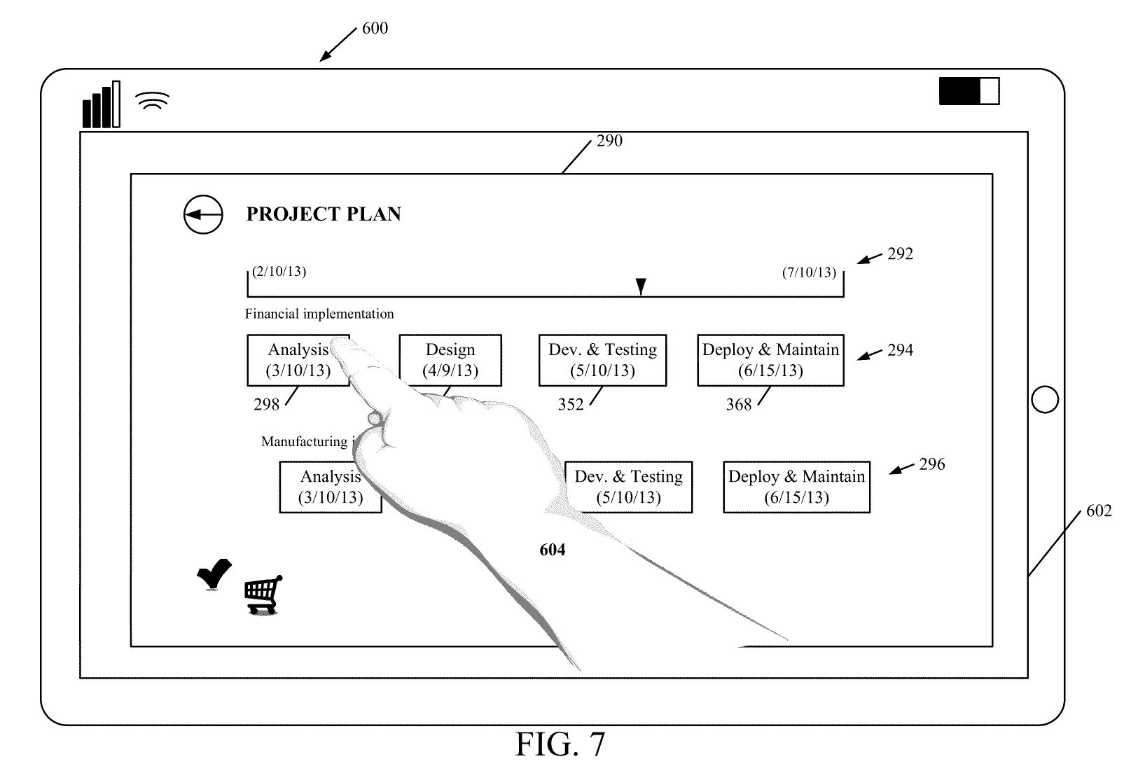

FIG. 6 is a simplified block diagram of one illustrative embodiment of a handheld or mobile computing device that can be used as a user's or client's hand held device 16, in which the present system (or parts of it) can be deployed. FIGS. 7-11 are examples of handheld or mobile devices.

FIG. 6 provides a general block diagram of the components of a client device 16 that can run components of architecture 100 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processors 122 or 172 from FIGS. 1A and 1B) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Application 154 or the items in data store 156, for example, can reside in memory 21. Similarly, device 16 can have a client business system 24 which can run various business applications or embody parts or all of system 118 or other systems or environments. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one embodiment in which device 16 is a tablet computer 600. In FIG. 7, computer 600 is shown with user interface display 230 (from FIG. 4A) displayed on the display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

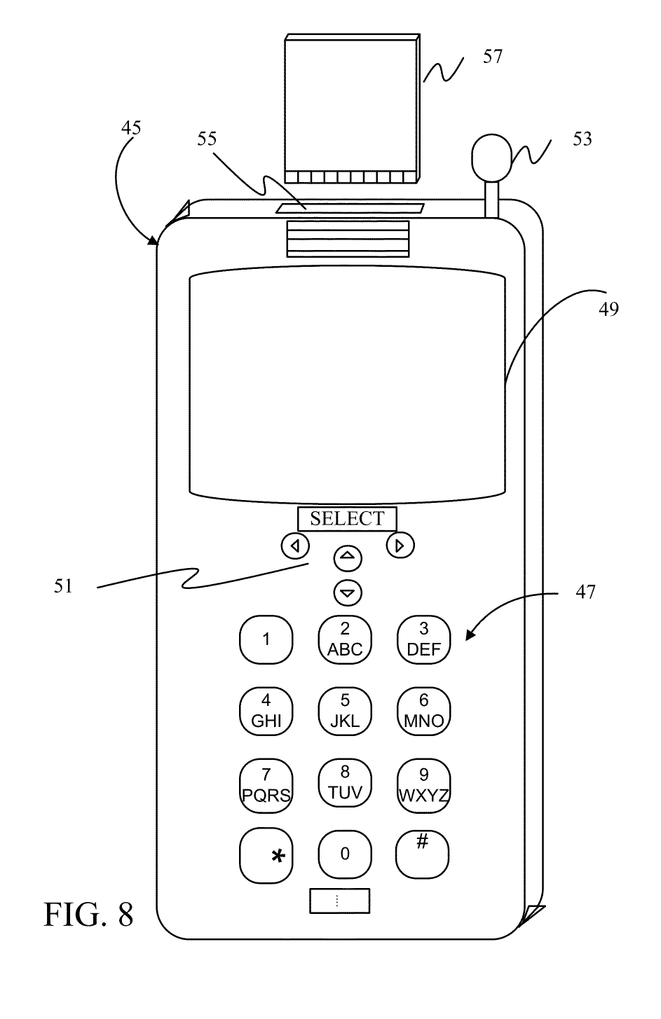

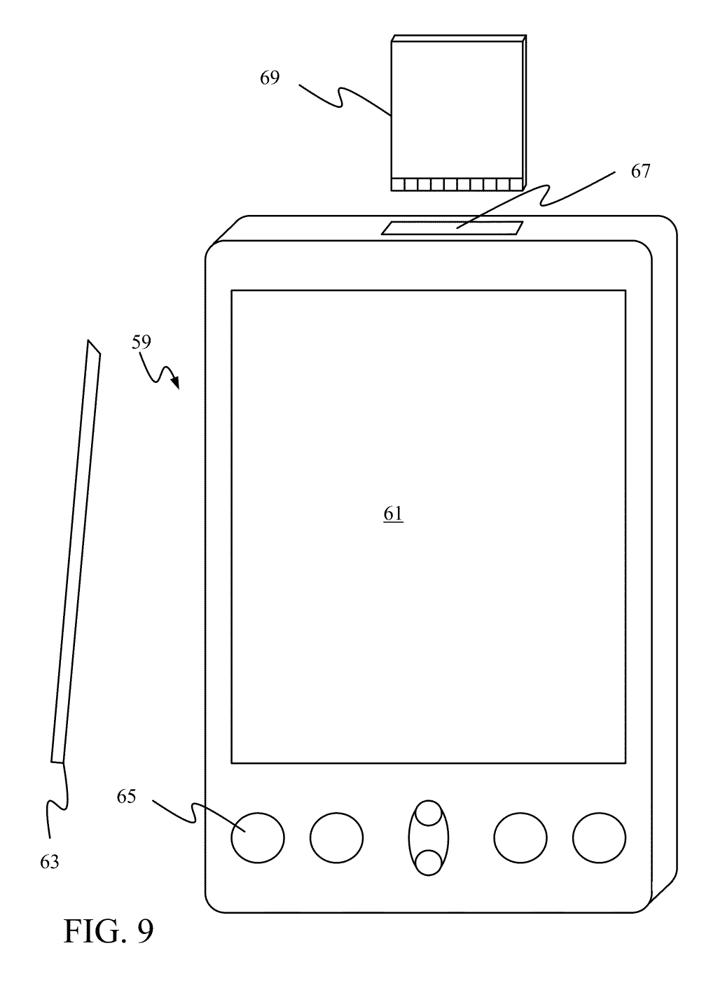

FIGS. 8 and 9 provide additional examples of devices 16 that can be used, although others can be used as well. In FIG. 8, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 9 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

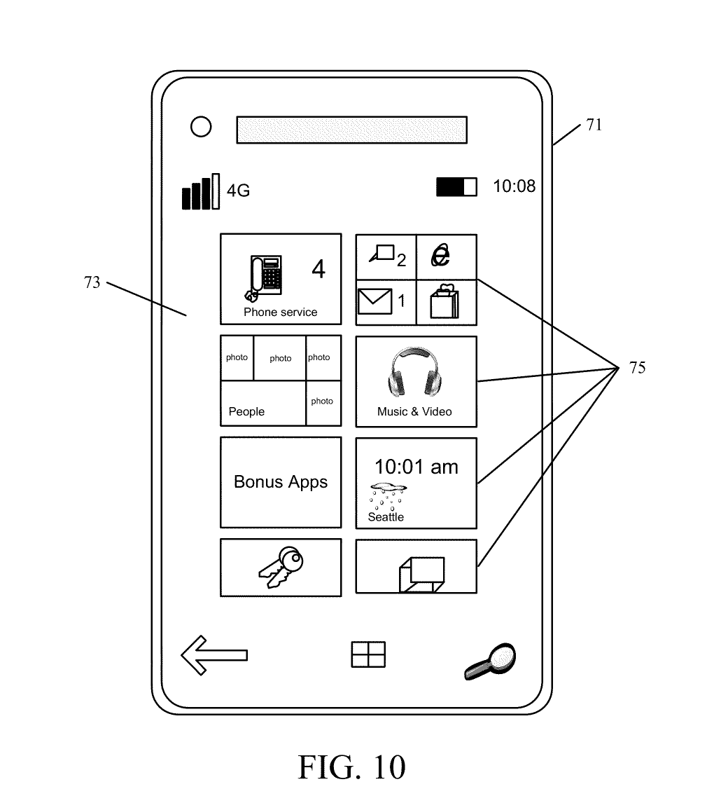

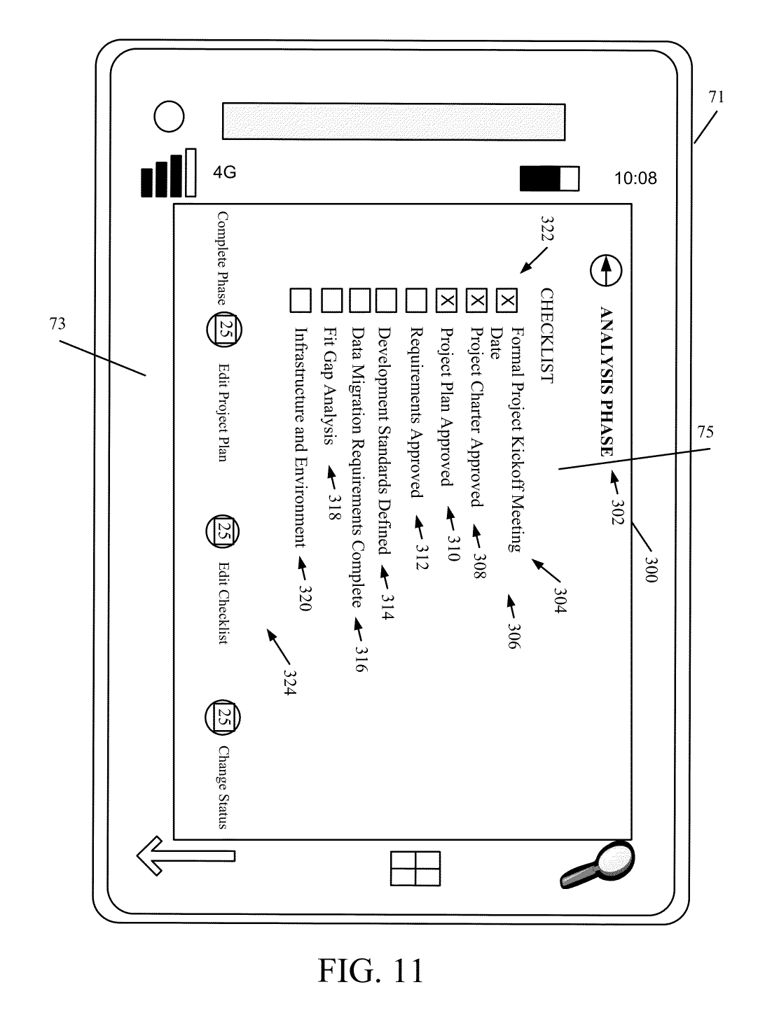

FIG. 10 is similar to FIG. 8 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone. FIG. 11 shows phone 71 with the display of FIG. 4C displayed on it.

Note that other forms of the devices 16 are possible.

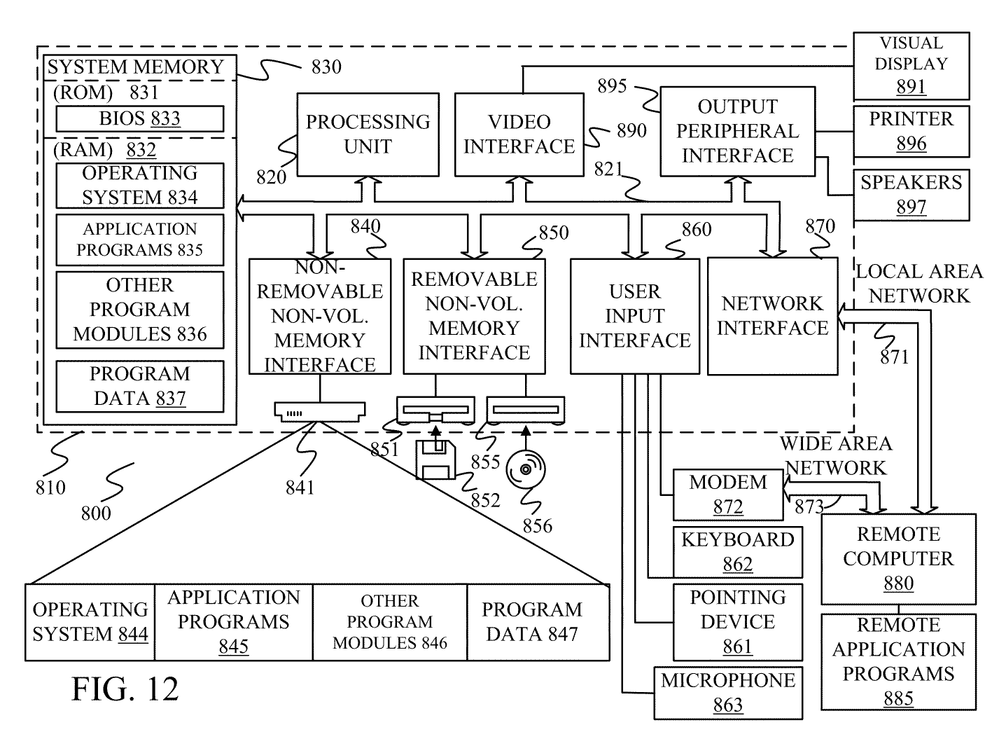

FIG. 12 is one embodiment of a computing environment in which architecture 100, or parts of it, (for example) can be deployed. With reference to FIG. 12, an exemplary system for implementing some embodiments includes a general-purpose computing device in the form of a computer 810. Components of computer 810 may include, but are not limited to, a processing unit 820 (which can comprise processor 122 or 172), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 12.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 12 illustrates operating system 834, application programs 835, other program modules 836, and program data 837.

The computer 810 may also include other removable/non-removable volatile/nonvolatile computer storage media. By way of example only, FIG. 12 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 12, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 12 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 12 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of implementing a computer system, comprising:
receiving a plurality of different inputs from a plurality of different services indicative of items to be addressed in customizing a computer system for a given deployment;
aggregating the items to be addressed, received from the plurality of different services, into a unified worklist, as worklist items;
receiving status inputs for the worklist items from a project management environment;
synchronizing the status inputs to the unified worklist; and
generating a report showing an indication of the worklist items and the synchronized status inputs.

2. The computer-implemented method of claim 1 wherein the computer system comprises a business system, wherein the given deployment comprises a deployment of the business system for a given customer, and wherein receiving a plurality of different inputs from a plurality of different services comprises:
receiving the plurality of different inputs from a plurality of different life cycle services, each life cycle service outputting the worklist items to be addressed identified during a given phase of the given deployment.

3. The computer-implemented method of claim 2 and further comprising:
storing the unified worklist with the synchronized status inputs for access by a report generator component.

4. The computer-implemented method of claim 3 and further comprising:
sharing the unified worklist and synchronized status inputs with a developer environment for visualization and action by a developer.

5. The computer-implemented method of claim 4 wherein sharing comprises:
sending the unified worklist and synchronized status inputs to a project management system for access by the developer environment.

6. The computer-implemented method of claim 4 wherein generating the report comprises:
generating a report indicating an amount of the worklist items, generated in each of a plurality of different phases, that have been addressed.

7. The computer-implemented method of claim 6 wherein each of the worklist items corresponds to a part of the business system that is to be customized and wherein generating a report comprises:
identifying the area of the business system corresponding to each of the worklist items; and
displaying the area of the business system corresponding to each of the worklist items along with an indication of the synchronized status inputs for the worklist items.

8. The computer-implemented method of claim 5 wherein generating a report comprises:
identifying a set of risks corresponding to the given deployment; and
displaying the set of risks identified.

9. The computer-implemented method of claim 8 wherein generating a report comprises:
displaying a mitigation suggestion for the displayed risks that indicates a task to take to mitigate the displayed risks.

10. The computer-implemented method of claim 5 wherein generating a report comprises:
displaying an amount of time spent to date on each of the worklist items.

11. The computer-implemented method of claim 5 wherein generating a report comprises:
displaying user actuatable input mechanisms corresponding to each of the worklist items, user actuation of the user actuatable input mechanism navigating the user to a more detailed display displaying more details for the corresponding worklist item.

12. A project life cycle computer system, comprising:
a worklist aggregator component that receives a plurality of different inputs from a plurality of different service components indicative of items to be addressed in customizing a computer system for a given deployment, and aggregating the items to be addressed, received from the plurality of different service components, into a unified worklist, as worklist items;
a synchronization component that shares the unified worklist with a project management system and synchronizes changes to the unified worklist received from the project management system, with the unified worklist on the computer system;
a report generator component that generates reports indicative of the status of the worklist items on the unified worklist; and
a computer processor being a functional part of the system and activated by the worklist aggregator component, the synchronization component and the report generator component to facilitate aggregating, synchronizing and generating the report.

13. The project life cycle computer system of claim 12 wherein the computer system being customized comprises a business system, wherein the given deployment comprises a deployment of the business system for a given customer, and wherein the plurality of different service components comprises:
a plurality of different life cycle service components, each life cycle service component outputting the worklist items to be addressed identified during a given phase of the given deployment.

14. The project life cycle computer system of claim 13 wherein the report generator component generates a report that displays a number of worklist items have been addressed and a number of worklist items that have not been addressed, based on the synchronized changes.

15. The project life cycle computer system of claim 14 wherein the report generator component generates a report that displays different parts of the business system, corresponding to the worklist items, that are to be modified to address the worklist items.

16. The project life cycle computer system of claim 15 wherein the report generator generates a report that displays an amount of the worklist items that correspond to each of the different parts of the business system and a status of the worklist items corresponding to each part of the business system.

17. A computer readable storage medium that stores computer executable instructions which, when executed by a computer, cause the computer to perform a method, comprising:
receiving a plurality of different inputs from a plurality of different services indicative of items to be addressed in customizing a computer system for a given deployment, each life cycle service outputting the items to be addressed identified during a given phase of the given deployment;
aggregating the items to be addressed, received from the plurality of different services, into a unified worklist, as worklist items;
receiving status inputs for the worklist items from a project management environment;
synchronizing the status inputs to the unified worklist; and
generating a report showing an indication of the worklist items and the synchronized status inputs.

18. The computer readable storage medium of claim 17 wherein the computer system comprises a business system, wherein the given deployment comprises a deployment of the business system for a given customer, and further comprising:
storing the unified worklist with the synchronized status inputs for access by a report generator component; and
sharing the unified worklist and synchronized status inputs with a developer environment for visualization and action by a developer.

19. The computer readable storage medium of claim 18 wherein sharing comprises:
sending the unified worklist and synchronized status inputs to a project management system for access by the developer environment.

20. The computer readable storage medium of claim 19 wherein generating a report comprises:
generating a report that traces the worklist items, and completion of the worklist items, from generation of the worklist items at a given phase of the project through completion of the project.
